(19) United States
(12) Patent Application Publication
(10) Pub. No.: US 2024/0060422 A1
(43) Pub. Date: Feb. 22, 2024

(54) TURBINE

(71) Applicant: Cummins LTD, London (GB)

(72) Inventors: Thomas Ogilvie, Yorkshire (GB); Alan Haigh, Yorkshire (GB); Matthew Mills, Yorkshire (GB); David Scott, Yorkshire (GB); Billy Stylianou, Yorkshire (GB)

(21) Appl. No.: 18/268,185

(22) PCT Filed: Dec. 16, 2021
(86) PCT No.: PCT/GB2021/053329

§ 371 Date: Jun. 16, 2023

(30) Foreign Application Priority Data
Dec. 17, 2020 (GB) 2020032.5

(51) Int. Cl. F01D 11/00; F01D 25/24; F01N 3/20

(52) U.S. Cl. CPC F01D 11/003; F01D 25/24; F01N 3/2066; F05D 2220/40; B33Y 80/00

(57) ABSTRACT

A turbine dosing sealing arrangement is disclosed. The sealing arrangement comprises a sealing member and a conduit. The sealing member is configured to engage a turbine housing element at an interface. The conduit projects from the sealing member, the conduit defining at least part of a reductant fluid pathway across the interface.

### CROSS-REFERENCE TO RELATED APPLICATION

This application claims the priority benefit of International Patent Application No. PCT/GB2021/053329, Dec. 16, 2021, which claims priority to GB Patent Application No. 2020032.5, filed Dec. 17, 2020, the entire contents and disclosures of which are incorporated herein by reference.

### TECHNICAL FIELD

The present disclosure relates to a turbine dosing sealing arrangement, a turbine dosing assembly, a turbine assembly, a turbocharger, a turbine housing element and associated methods.

### SUMMARY

Internal combustion engines, such as diesel engines, may emit carbon monoxide, hydrocarbons, particulate matter and nitrogen oxide compounds (NOX) in the exhaust. There are a number of legal requirements throughout the world which govern emission standards, and these requirements are becoming increasingly stringent, particularly in relation to nitrogen oxides (NOX) emissions. To reduce NOX emissions engine manufacturers may make use of exhaust gas recirculation and selective catalytic reduction (SCR).

Selective catalytic reduction (SCR) is an exhaust gas after-treatment, used to convert NOX into compounds that are less reactive, such as diatomic nitrogen and water, with the aid of a catalyst and a reductant. A liquid-reductant agent, such as anhydrous ammonia, aqueous ammonia, or urea, all which may be commonly referred to as Diesel Exhaust Fluid (DEF), is injected into the exhaust stream upstream of the catalyst.

In order to effectively convert the nitrogen oxides of the exhaust gas, the correct amount of DEF for given operating conditions is required, and efficient mixing of the DEF with the exhaust gas flow must also occur.

It is known to dose DEF into a turbine exhaust stream, such as into a dosing cup, to reduce NOX emissions. However, existing solutions lack the desired performance and/or longevity. There exists a need to provide an alternative solution that overcomes one or more of the disadvantages of known arrangements, whether mentioned in this document or otherwise.

According to a first aspect of the disclosure there is provided a turbine dosing sealing arrangement comprising:
a sealing member configured to engage a turbine housing element at an interface; and
a conduit which projects from the sealing member, the conduit defining at least part of a reductant fluid pathway across the interface.

The turbine dosing sealing arrangement refers to a sealing arrangement suitable for use with dosing systems. The dosing system may be for injecting a reductant fluid into an exhaust gas stream, which may be from an internal combustion engine. The exhaust gas stream may pass through a central region defined by the turbine housing element. The exhaust gas may subsequently exit the turbine housing element, into an exhaust manifold or pipe (for example).

The sealing member is configured to engage the turbine housing element at an interface, such that leakage of exhaust gas and/or reductant fluid across the interface is reduced or eliminated. The sealing member may be a single component that is configured to engage the turbine housing element at the interface. Alternatively, the sealing member may comprise a plurality of components, one or more of which may engage (optionally cooperatively) the turbine housing element at the interface. The sealing member engages, and seals, at least a portion of the turbine housing element. Said portion may, for example, be where the conduit extends through the turbine housing element. The sealing member may at least partly define the interface. The sealing member may also support the conduit. The sealing member may be elongate. That is to say, the sealing member may be longer, or taller, than it is wide.

The turbine housing element may, for example, be a turbine housing or a diffuser. In other instances, the turbine housing element may be an adapter element, which refers to a component which is provided between a turbine (specifically a housing thereof) and a downstream conduit. The adapter element may, for example, interpose a turbine (specifically a housing thereof) and an exhaust manifold, or pipe.

The interface refers to a boundary between the sealing member and the turbine housing element. The interface may be described as a sealing, or fluid-tight, boundary. The interface may refer to the region, between adjacent surfaces of the sealing member and turbine housing element, where said surfaces contact one another. The interface may be described as a contact, or engagement, face. The interface may be, for example, generally annular (extending, for example, around, or within, a boss). Alternatively, the interface may have any one of a wide range of different geometries. The interface may be defined, at least partly, by a surface of the sealing member. The interface may be defined, at least in part, by an aperture, or opening, provided in the turbine housing element (which is engaged by the sealing member). The interface may be defined, at least in part, by a channel or boss, which forms part of the turbine housing element. The interface may form a closed loop (e.g. the interface geometry may be a closed shape, such as a circle or ellipse).

The conduit may be a channel, pipe or any other suitable passage that is capable of transporting a fluid, in particular a reductant liquid. The conduit may be a formed as a single, monolithic structure. Alternatively, the conduit may be formed of a plurality of portions (e.g. the conduit may comprise a plurality of constituent portions). Where the conduit comprises a plurality of portions, the portions may be the same material, or differing materials. For example, a first portion of the conduit may be metallic, and the second portion may be manufactured from a flexible material, such as rubber. The conduit projecting from the sealing member may be a conduit extending in a first direction from the sealing member; a conduit extending in a second direction; or a conduit that extends in both a first and second direction from the sealing member. The conduit may extend at least partway through the sealing member, and may extend through an entire extent (e.g. height) of the sealing member. The conduit may extend across the interface.

The reductant fluid pathway defines a path that fluid reductant may take. The conduit defines at least part of said path. Put another way, the overall fluid pathway may extend beyond the conduit forming part of the turbine sealing arrangement. By way of an example, the (whole) reductant fluid pathway may extend from a reductant reservoir, through the conduit or through a plurality of conduits, to an outlet (proximate the turbine). Reductant fluid may therefore pass along the fluid pathway, from a reservoir, through the conduit or through a plurality of conduits, to the outlet where it is then injected into an exhaust gas stream. The reductant fluid pathway may extend from a component, or region, outside of the turbine housing element, across the interface, to the central region. The outlet may be disposed proximate the central region. Reductant fluid may be actively pumped along the reductant fluid pathway, for example by a pump, or may pass along the pathway under the force of gravity (e.g. be drip-fed).

The conduit, that defines at least part of the reductant fluid pathway, is suitable for transporting reductant fluid. The reductant fluid may be a liquid reductant agent, such as anhydrous ammonia, aqueous ammonia, or urea, which may all be commonly referred to as diesel exhaust fluid (DEF). In use, the reductant fluid may flow through along the reductant fluid pathway and be expelled towards the central region of the turbine housing element (into an exhaust gas stream). The reductant fluid may be expelled towards a turbine wheel. The reductant may be expelled towards a dosing cup, or dosing wheel, which may form part of the turbine wheel. After reductant fluid has been ejected, or expelled, from the conduit, it may be atomised by the dosing cup/wheel. Said atomisation may facilitate the mixing of the reductant in the exhaust stream. The reductant fluid may also precipitate on an outer surface of the conduit after being expelled from the conduit. The conduit may be brazed in silver. Silver is inert to ammonia and so brazing the conduit in silver reduces the risk of the conduit corroding due to the reductant fluid.

Some reductants, such as urea, can form by-products in use. The by-products may be corrosive acids. Example by-products are, but not limited to, isocyanic acid and cyanuric acid, melamine, ammeline and ammelide. The by-products and urea can be detrimental to the robustness of the materials from which the turbine housing element is made. Put another way, reductant fluid by-products can be corrosive to turbine housing elements (among other components) made of certain materials (for example, cast iron). Advantageously, the sealing member engaging the turbine housing element at the interface alleviates corrosion issues by reducing, or preventing altogether, reductant fluid and/or reductant fluid by-product from passing across the interface. Circumstances in which the liquid reductant and/or reductant fluid by-product may contact components which surround the turbine housing element include engine shutdown and/or the turbine being inclined (e.g. where the turbine is incorporated in a vehicle).

The sealing advantageously reduces the risk of the reductant fluid from corroding structures which may encompass, or support, the turbine housing element. For example, the turbine housing element which the sealing member engages may be a diffuser. The diffuser may be mounted within a turbine housing. The sealing arrangement may substantially prevent reductant fluid and/or reductant by-products from contacting the turbine housing, which may be more liable to corrode than the diffuser.

The sealing member and conduit may be used in combination with turbine housing elements manufactured from known, corrosion-prone materials (such as cast iron). Incorporation of the turbine dosing sealing arrangement can therefore facilitate the incorporation of turbine dosing technology, to reduce emissions, in turbine housing elements made of known materials. The turbine dosing sealing arrangement thus extends the lifetime of a known turbine housing element, and surrounding components, by reducing the corrosion which may otherwise result from reductant fluid (owing, in turn, to the incorporation of turbine dosing technology). Put another way, the turbine dosing sealing arrangement reduces the risk of corrosion which may otherwise be present by virtue of incorporating emissions-reducing dosing technology (and specifically due to reductant fluid and/or reductant fluid by-product contacting cast iron components).

Advantageously, by reducing the risk of reductant fluid from leaking from an internal region of the turbine housing element, through use of the sealing member, reductant fluid wastage is decreased and, in turn, the proportion of nitrous oxides that are reduced by the reductant fluid is increased. Furthermore, the risk of reductant by-products leaking is also reduced.

The sealing member and/or conduit may be replaceable components. Advantageously, this allows the components to be removed and replaced using either the same component, or a new component, during routine maintenance, repair and testing of a turbine.

The sealing member may comprise a plug, and wherein the conduit extends from the plug.

The plug is intended to mean a component that blocks at least part of, or all of, an (unwanted) fluid leakage path. The leakage path refers to a path other than the reductant fluid pathway. The plug, and sealing member more generally, may prevent leakage of reductant fluid and/or reductant fluid by-product and/or exhaust gas across the interface. The plug may otherwise be described as a bung or stopper.

The plug may be cast or forged e.g. be manufactured from a metal material. The plug, or at least a part thereof, may be resiliently deformable. The plug may engage with the turbine housing element through a friction fit, interference fit, press fit, or any other similar fit which results in the plug positively engaging with the turbine housing element. This may be without the need for additional parts, or components, in order for the plug to remain in an engaged position. With that said, in some arrangements the plug may be secured, or retained, in position by one or more fixtures (such as a fastener).

The plug may be secured over a portion of the turbine housing element. The plug may be secured within a portion of the turbine housing element. Said portion may be a boss, which may comprise an aperture.

Advantageously, the sealing member comprising a plug means that the sealing member can be easily removed, and subsequently replaced. Furthermore, the plug securely engages the turbine housing element each time the plug is re-engaged with the element.

The conduit extending from the plug is intended to cover the conduit extending from an end, or portion, of the plug, but also extending through the plug. The conduit may comprise multiple sections, or portions. The joining, or merging, of two or more sections, or portions, may occur within the plug. Advantageously, such arrangement reduces the risk of any reductant fluid on an external, or outer, surface of the conduit from contacting the turbine housing element and subsequently causing corrosion.

The plug may comprise a cavity for the collection of fluid.

The cavity for the collection of fluid may be referred to as a fluid cavity. The fluid may be reductant fluid that has precipitated onto, or collected on, an external surface of the conduit. The fluid may have travelled across the interface along an unwanted fluid pathway (e.g. a leakage pathway).

The plug may comprise a first end which is proximate the interface. The plug may further comprise a flanged second end, which may be referred to as a flanged portion. The flanged second end may be configured to engage a different, second turbine housing element (e.g. where the first turbine housing element is a diffuser, and the second turbine housing element is a turbine housing). The flanged second end may engage the second turbine housing element by a friction fit and/or be retained by a least one fastener. The fastener may be threaded fastener, such as bolt or screw, which can be readily disassembled if required. The flanged second end may engage the second turbine housing element so as to exert a pressure on the second turbine housing element, and act as a sealing region. The flanged end may also engage with the second turbine housing element to retain the plug in its engaged position.

Fluid collected in the cavity may be removed (e.g. emptied) when removing the plug itself. Alternatively, or in combination, the exhaust gas stream may heat the turbine housing element, and the sealing member (e.g. to in excess of 1000 degrees Celsius), and evaporate, or ‘burn off’ any reductant liquid present in the cavity of the plug.

Therefore, not only does the plug comprising the cavity reduce the risk of reductant fluid and/or reductant fluid by-product from corroding the turbine housing elements and other components, but the vaporisation of reductant liquid allows for reductant fluid to essentially be re-used. This is in contrast to said collected fluid otherwise having been wasted, and risking corrosion of the turbine housing element.

The plug may comprise a sleeve.

The sleeve may define the cavity. The sleeve may be generally conical, or frustoconical. The conduit may extend through the sleeve. The conduit may be integrally formed with the sleeve. The sealing member may comprise an inert seal.

The inert seal may at least partly define the interface. The inert seal may be provided at a first end of the sealing member. Inert seal refers to a seal made of a material which is generally non-reactive, or of a low reactance, with reductant fluid, reductant fluid by-products, oxygen, carbon dioxide, nitrogen, water (vapour or liquid), or any other fluid that is commonly found in the atmosphere and/or exhaust gases and/or reductant dosing systems. The inert seal may be a gasket, an O-ring, a C-seal, or any other suitable seal. The inert seal may be described as a compliant seal (e.g. a resiliently biased seal, which can be elastically compressed).

An advantage of providing an inert seal is that, if a corrosive fluid contacts the seal, the seal is resistant to corrosion. The inert seal thus reduces the risk of the corrosive fluid from travelling to, and contacting, other parts of the turbine housing element or other components of a turbine, such as a cast turbine housing.

The inert seal may be a graphite seal.

Advantageously, graphite is able to withstand high temperatures, such as those reached by exhaust gases. In addition, a graphite seal has relatively low creep (i.e. deformation owing to persistent mechanical stresses), and is resistant to becoming brittle over time, thus extending the lifetime of the turbine dosing sealing arrangement.

The inert seal may be a first seal, the sealing member may further comprise a second seal; and the first and second seals may be spaced apart.

The second seal may also be an inert seal. The first and second seals may be concentric seals (e.g. they may extend around a surface). The first and second seals may be spaced apart from one another along an axis of the conduit. One or both of the seals may at least partly define the interface. Each seal may engage a respective turbine housing element. Further seals may be disposed between the first and second seals.

Either or both of the seals may be compressed in an axial and/or radial manner to provide a sealed engagement between the sealing member and the (respective) turbine housing element.

The sealing member may comprise a compression fitting member.

The compression fitting member may be configured to secure at least two portions of conduit in fluid communication with one another, in a substantially leak-free manner.

The compression fitting member may exert a force on the turbine housing element and/or onto the conduit. The force may be adjustable, depending upon the extent of the engagement of the compression fitting member with either component.

The compression fitting member may be disassembled and removed and/or replaced during maintenance, repair and testing. The force exerted upon the conduit and/or the turbine housing element may be adjusted by rotating a portion of the compression fitting member. A portion of the compression fitting member may be rotated in a first rotational direction to increase the force, and in a second, opposing, rotational direction to reduce the force.

It will be appreciated that references to force may otherwise be described as a pressure applied over an area.

The compression fitting member may be received in a portion of the turbine housing element. The compression fitting member may be complementary in shape to the corresponding portion of the turbine housing element.

A biasing element may be disposed around, or at, an end of the compression fitting member. Said biasing element may interpose the compression fitting member and another part of the sealing member (e.g. a first portion of the sealing member).

The biasing element may be a washer, preferably a conical spring washer. The washer is able to withstand high pressures which may be applied via the compression fitting, and high temperatures.

The compression fitting member may clamp around an olive. The olive may be provided around a conduit. The compression fitting member may comprise a sealing element and a mounting member.

The compression fitting member may define a bore.

The conduit may extend at least partly through the bore. The conduit may extend entirely through the bore. Where the conduit comprises a plurality of separate portions, said separate portions may be joined together in the bore of the compression fitting member. The compression fitting member may be configured to seal the portions together to reduce the risk of, or prevent, fluid in the conduit from leaking. The compression fitting member may exert a force on the two or more portions of the conduit to reduce, or prevent, fluid leakage.

The compression fitting member may support the conduit. The compression fitting member retain the conduit in position relative to the turbine housing element.

The sealing member may be brazed to the conduit. In particular, the conduit may be brazed to the compression fitting member in the bore. Brazing the conduit to the sealing member reduces, or prevents, leakage through the sealing member. The sealing member may be brazed to the turbine housing element. Brazing the sealing member to the turbine housing element retains the sealing member in a fixed position relative to the turbine housing element. The brazing also reduces the risk of, or prevents, leaked reductant fluid from contacting the turbine housing element and other components of a turbine (which may be susceptible to corrosion).

The bore may form part of the conduit. Where the bore forms part of the conduit, fluid is able to flow directly through the bore (e.g. along the arcuate surfaces which define the bore).

A first portion of the conduit may be inclined relative to a second portion of the conduit.

In situ, the conduit may extend towards a dosing structure, such as a dosing cup or dosing wheel. Reductant from the conduit may be expelled, or injected, into the dosing structure to promote atomization of the reductant. As such, at least one end of the conduit may be angled generally towards, or along, a longitudinal, or central, axis. The at least one end of the conduit may be described as being directed towards the dosing structure and/or the central axis.

In order for the expulsion, or outlet, end of the conduit to be inclined relative to the dosing structure, it may be inclined, or provided at an angle to, a second portion of the conduit. In such instance, the expulsion, or outlet end, of the conduit may be referred to as a first portion of the conduit. The second portion of the conduit, in this instance, may be a portion of the conduit that directly projects from the sealing member proximate the interface. Accordingly, the conduit may be described as comprising a bend and/or incorporating a change in direction. Said bend or change in direction may be proximate, or at, a first side of the interface.

During installation, the second portion of the conduit may first be passed through an aperture in the turbine housing element. The subassembly may be rotated during installation to facilitate passage of the curved conduit (e.g. the first portion, or a region between the first and second portions) through the aperture. An aperture having a diameter greater than a diameter of the conduit may be incorporated to facilitate installation. The sealing member may advantageously have a diameter greater than the conduit. The sealing member may, in effect, plug, or close, any clearance defined between the conduit and the aperture once the subassembly is in situ. In this manner, the aperture can be large enough to allow the curved portion of the conduit to be manipulated through the aperture, but is also sealed by the sealing member (at the interface) to reduce, or prevent, reductant fluid leakage thereacross.

According to a second aspect of the disclosure there is provided a turbine dosing assembly for a turbine, the turbine dosing assembly comprising:
a turbine housing element; and
a) the turbine dosing sealing arrangement according to any preceding claim.

The turbine housing element may be a turbine housing, a diffuser, or an adapter element. Adapter element refers to a component which is provided between a turbine housing and a downstream conduit (e.g. an exhaust manifold). The adapter element may, for example, interpose a turbine housing and an exhaust manifold or pipe. The turbine wheel may be generally enclosed by the turbine housing.

The turbine dosing sealing arrangement may engage multiple turbine housing elements (e.g. a turbine housing and a diffuser).

The turbine housing element may comprise a boss; and wherein the interface may be defined at least partly by the boss.

The boss may be a protruding feature that extends from the turbine housing element. The boss defines a thickened portion of material. The boss may comprise a channel. The reductant fluid pathway may extend through the boss. The conduit may extend through the boss.

Advantageously, the boss provides a greater surface area which the sealing member can engage. The boss may be generally cylindrical in shape. The boss may also comprise a location feature, such as a recess or protrusion. The sealing member may comprise a complementary location feature (such as a protrusion or recess respectively). The incorporation of one or more location features facilitates the ready positioning of the sealing member, in a desired alignment, even following disassembly and reassembly of the turbine dosing assembly.

The sealing member may engage the boss. The sealing member may engage an inner surface of the boss and/or an outer surface of the boss and/or an end of the boss.

A portion of the plug may be received within the boss. The boss may be configured to receive a first end of the plug. The first end of the plug may be retained within the boss. The plug may sealingly engage a surface of the boss. Advantageously, fluid is less likely to, or prevented from, passing between the plug and the boss.

The turbine housing element may be a first turbine housing element; and a portion of the plug may engage a second turbine housing element. The first turbine housing element may be a diffuser, and the second turbine housing element may be a turbine housing, or vice versa. Alternatively, the first turbine housing element may be a diffuser, and the second turbine housing element may be an adapter element.

The first and second turbine housing elements may be radially spaced apart such that there is a gap between the first and second turbine housing elements. Said gap may be a bypass channel, for the passage of bypass gases, where the turbine dosing assembly forms part of a wastegated turbine. The first and second turbine housing elements may be concentrically aligned with one another. In other words, a centerline of the first and second turbine housing elements may be disposed along the (common) central axis.

The inert seal may be disposed between the boss and the plug. The inert seal may be provided between an end of the boss and an end of the plug. The seal may surround a portion of the boss, or the sealing member. The inset seal may be attached to the sealing member such that, upon installation of the sealing member, the inert seal is compressed between the sealing member and the boss. The boss may comprise a recess, or seal seat, configured to receive the seal.

Providing the seal between the boss and the plug and the boss further improves the sealing function of the sealing member, reducing the risk of corrosion due to leakage of reductant fluid and/or reductant fluid by-product.

According to a third aspect of the disclosure there is provided a turbine assembly comprising:
a) a turbine wheel; and
b) the turbine dosing assembly according to the second aspect of the disclosure.

The turbine may form part of a turbocharger. Alternatively, the turbine may be a power turbine.

According to a fourth aspect of the disclosure there is provided a turbocharger comprising:
a compressor;
a bearing housing; and
the turbine assembly according to the third aspect of the disclosure;
a) wherein the turbine and compressor are in power communication.

The turbocharger may be a fixed geometry turbocharger. The turbocharger may be a variable geometry turbocharger. The turbocharger may be a wastegate turbocharger.

The turbocharger may form part of an engine arrangement. The engine arrangement may be part of a vehicle, such as an automobile. The engine arrangement may have a static application, such as in a pump arrangement or in a generator.

According to a fifth aspect of the disclosure there is provided a turbine housing element for a turbine, the turbine housing element comprising:
a wall extending between an inlet and an axially offset outlet, the wall defining an inner surface and an outer surface; and
a conduit, configured to receive, and expel, reductant, the conduit projecting from, and being integrally formed with, the inner surface of the wall;
a) wherein the conduit comprises an attachment portion configured to threadably engage a further conduit.

The turbine housing element may be a diffuser. Where the diffuser comprises a conduit, the diffuser may be referred to as a reductant dosing diffuser.

The inlet and outlet being axially offset is intended to mean the inlet and outlet are separated from one another. Described another way, the outlet is downstream of the inlet. The inlet and outlet refer to an exhaust stream inlet and outlet. The wall may be said to guide, or direct, the flow. The inner surface may be described as a boundary of the exhaust stream.

The conduit may be described as a reductant fluid pipe. The conduit may be configured to receive reductant from a reductant source. In use, the conduit may expel reductant fluid towards a dosing structure, such as a dosing cup or dosing wheel.

The attachment portion may be a thread (e.g. a screw thread, which may be male or female). The attachment portion may be provided at an absolute end (e.g. an outer end) of the conduit. The attachment portion may be provided on an exterior of the conduit. The attachment portion may be provided on an interior of the conduit. As such, the attachment portion may be an internal, or external, screw thread. The conduit may terminate at a boss, which extends from the wall. The conduit may extend entirely through the wall. The attachment portion may be provided as part of the boss (e.g. the boss may comprise a thread).

The conduit may be connected to a reductant supply line (which may, in turn, be in fluid communication with a reductant source). The provision of the thread provides a convenient mechanism for connecting, and disconnecting, the reductant supply line during (for example) installation, maintenance, repair, or testing of the turbine assembly.

In addition, a portion of the conduit may be inclined relative to the reductant supply line when the two components are threadably engaged with one another. This obviates the need to feed the reductant supply line through the wall, and angle the reductant supply line, during installation. Installation is thus more straightforward.

The conduit being integrally formed with the inner surface of the wall is intended to mean that the conduit and inner surface form a single, monolithic component. No joining process may be required to attach the conduit to the inner surface. There may be no join line between the conduit and the inner surface of the wall.

The conduit may be a pipe. The conduit may be an angled pipe. The conduit may have an exterior structure having an aerodynamic profile, such as an aerofoil.

According to a sixth aspect of the disclosure there is provided a computer program comprising computer executable instructions that, when executed by a processor, cause the processor to control an additive manufacturing apparatus to manufacture a turbine dosing sealing arrangement, optionally according to the first aspect of the disclosure, or a turbine housing element according to the fifth aspect of the disclosure.

The turbine dosing sealing arrangement and/or turbine housing element, may be in accordance with the above aspects of the disclosure, incorporating any optional features provided in connection with the above aspects.

According to a seventh aspect of the disclosure there is provided a method of installing a turbine dosing sealing arrangement according to the first aspect of the disclosure, the method comprising:

urging the sealing member into engagement with the turbine housing element.

The turbine dosing sealing arrangement allows for a simple and convenient method of engaging the sealing member with the turbine housing element.

The method may further comprise retaining the sealing member in said engagement. The method may further comprise securing the sealing member with fasteners, such as bolts.

The method may further comprise urging the conduit through at least a portion of the sealing member.

The method may further comprise inserting the conduit through an aperture provided in the turbine housing element, and subsequently urging the sealing member into engagement with the turbine housing element (optionally to define the interface).

According to an eighth aspect of the disclosure there is provided a method of manufacturing a turbine dosing sealing arrangement, or a turbine housing element, via additive manufacturing, the method comprising:
obtaining an electronic file representing a geometry of the turbine dosing sealing arrangement or the turbine housing element; and
controlling an additive manufacturing apparatus to manufacture, over one or more additive manufacturing steps, the turbine dosing sealing arrangement, or the turbine housing element according to the fifth aspect of the disclosure, according to the geometry specified in the electronic file;
optionally wherein the turbine dosing sealing arrangement is according to the first aspect of the disclosure.

The turbine dosing sealing arrangement, and/or turbine housing element may be in accordance with the above aspects of the disclosure, incorporating any optional features provided in connection with the above aspects.

The optional and/or preferred features for each aspect of the disclosure set out herein are also applicable to any other aspects of the disclosure, where appropriate.

### BRIEF DESCRIPTION

Specific embodiments of the present disclosure will now be described, by way of example only, with reference to the accompanying drawings in which:

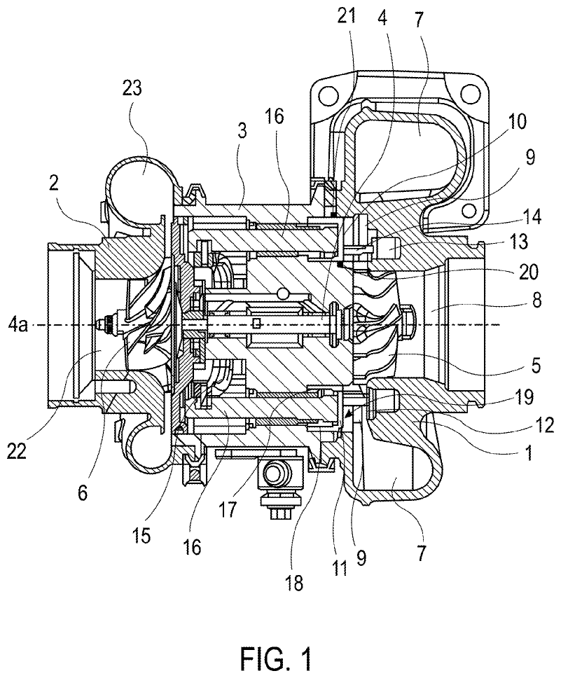

FIG. 1 is a cross-section side view of a known variable geometry turbocharger;

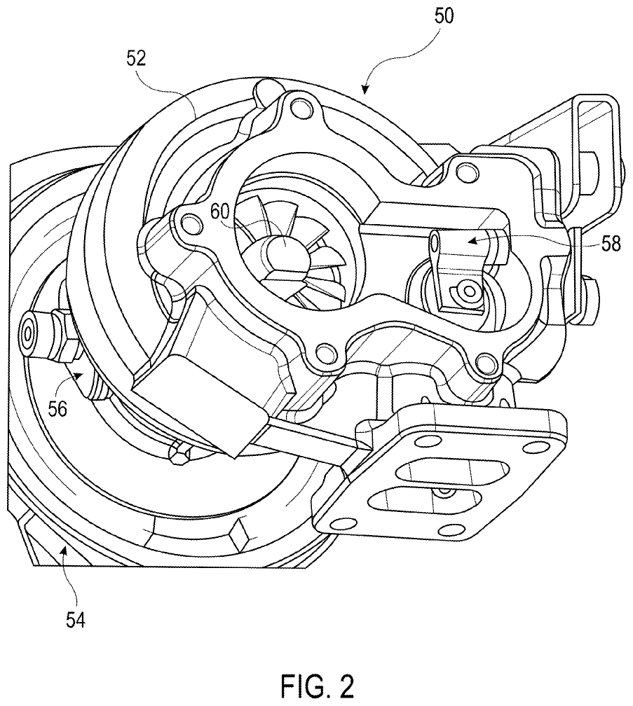

FIG. 2 is a perspective view of part of an alternative known turbocharger that incorporates a wastegate;

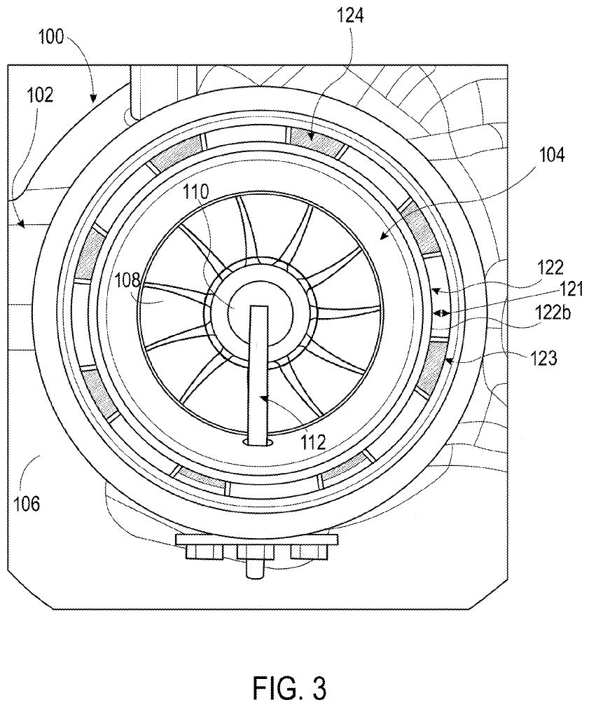

FIG. 3 is an end view of part of a turbine assembly incorporating a turbine dosing sealing arrangement according to an embodiment of the disclosure;

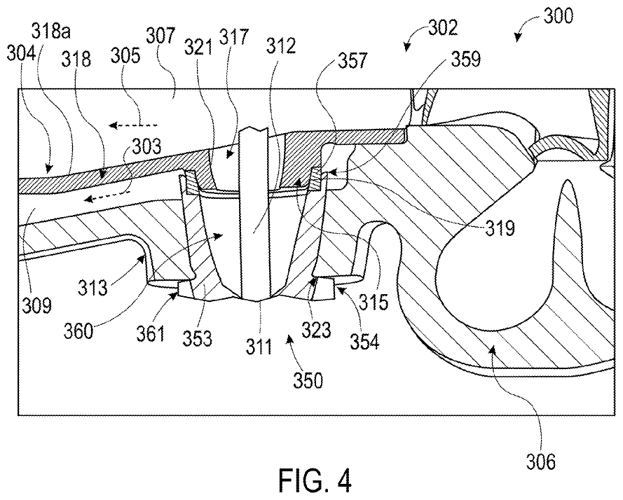

FIG. 4 is a cross-section side view of part of a turbine assembly incorporating a turbine dosing sealing arrangement according to an embodiment of the disclosure;

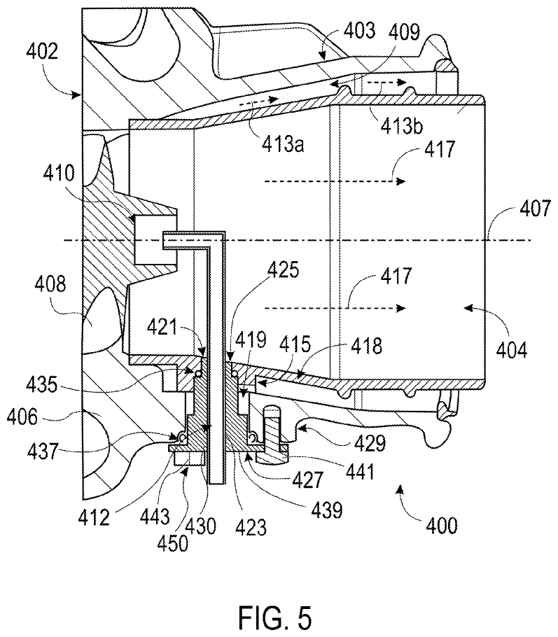

FIG. 5 is a cross-section side view of a turbine assembly comprising a turbine dosing sealing arrangement according to another embodiment of the disclosure;

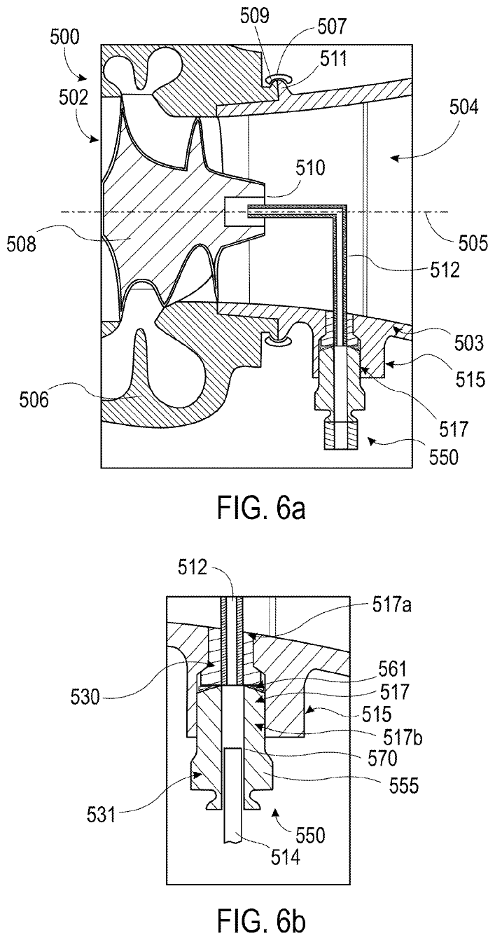

FIG. 6a is a cross-section side view of part of a turbine assembly comprising a turbine dosing sealing arrangement according to another embodiment of the disclosure;

FIG. 6b is an enlarged cross-section view of a region of interest of the turbine dosing sealing arrangement of FIG. 6a; and

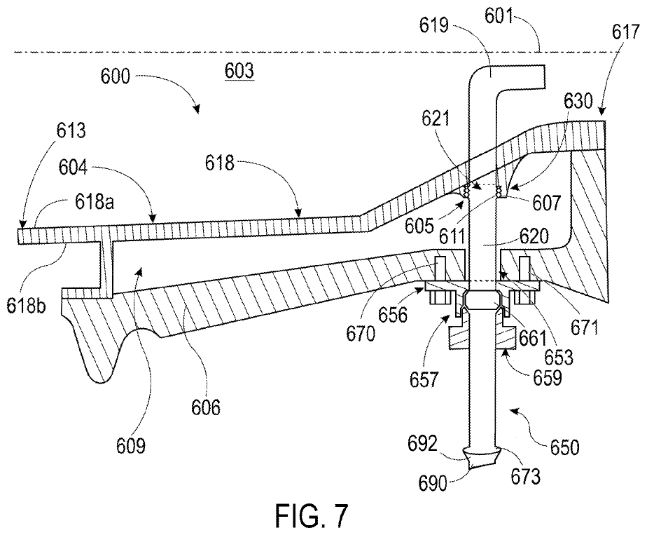

FIG. 7 is a cross-section side view of part of a turbine assembly comprising a turbine dosing sealing arrangement, according to another embodiment of the disclosure, and a turbine housing element, according to a further embodiment of the disclosure.

FIG. 1 is a cross-section side view of a known variable geometry turbocharger. The turbocharger comprises a (variable geometry) turbine housing 1 and a compressor housing 2 interconnected by a central bearing housing 3. A shaft 4 extends from the turbine housing 1 to the compressor housing 2 through the bearing housing 3. A turbine wheel 5 is mounted on one end of the shaft 4 for rotation within the turbine housing 1, and a compressor wheel 6 is mounted on the other end of the shaft 4 for rotation within the compressor housing 2. The turbine wheel 5 and compressor wheel 6 are therefore in power communication with one another. The shaft 4 rotates about turbocharger axis 4a on bearing assemblies located in the bearing housing 3.

The turbine housing 1 defines an inlet volute 7 to which gas from an internal combustion engine (not shown) is delivered. The exhaust gas flows from the inlet volute 7 to an axial outlet passageway 8 via an annular inlet passageway 9 and the turbine wheel 5. The inlet passageway 9 is defined on one side by a face 10 of a radial wall of a movable annular wall member 11, commonly referred to as a “nozzle ring”, and on the opposite side by an annular shroud 12 which forms the wall of the inlet passageway 9 facing the nozzle ring 11. The shroud 12 covers the opening of an annular recess 13 in the turbine housing 1.

The nozzle ring 11 supports an array of circumferentially and equally spaced inlet vanes 14 each of which extends across the inlet passageway 9. The vanes 14 are orientated to deflect gas flowing through the inlet passageway 9 towards the direction of rotation of the turbine wheel 5. When the nozzle ring 11 is proximate to the annular shroud 12, the vanes 14 project through suitably configured slots in the shroud 12, into the recess 13.

The position of the nozzle ring 11 is controlled by an actuator assembly of the type disclosed in U.S. Pat. No. 5,868,552. An actuator (not shown) is operable to adjust the position of the nozzle ring 11 via an actuator output shaft (not shown), which is linked to a yoke 15. The yoke 15 in turn engages axially extending actuating rods 16 that support the nozzle ring 11. Accordingly, by appropriate control of the actuator (which may for instance be pneumatic or electric), the axial position of the rods 16 and thus of the nozzle ring 11 can be controlled.

The speed of the turbine wheel 5 is dependent upon the velocity of the gas passing through the annular inlet passageway 9. For a fixed rate of mass of gas flowing into the inlet passageway 9, the gas velocity is a function of the width of the inlet passageway 9, the width being adjustable by controlling the axial position of the nozzle ring 11. FIG. 1 shows the annular inlet passageway 9 fully open. The inlet passageway 9 may be closed to a minimum by moving the face 10 of the nozzle ring 11 towards the shroud 12.

The nozzle ring 11 has axially extending radially inner and outer annular flanges 17 and 18 that extend into an annular cavity 19 provided in the turbine housing 1. Inner and outer sealing rings 20 and 21 are provided to seal the nozzle ring 11 with respect to inner and outer annular surfaces of the annular cavity 19 respectively, whilst allowing the nozzle ring 11 to slide within the annular cavity 19. The inner sealing ring 20 is supported within an annular groove formed in the radially inner annular surface of the cavity 19 and bears against the inner annular flange 17 of the nozzle ring 11. The outer sealing ring 20 is supported within an annular groove formed in the radially outer annular surface of the cavity 19 and bears against the outer annular flange 18 of the nozzle ring 11.

Gas flowing from the inlet volute 7 to the outlet passageway 8 passes over the turbine wheel 5 and as a result torque is applied to the shaft 4 to drive the compressor wheel 6. Rotation of the compressor wheel 6 within the compressor housing 2 pressurises ambient air present in an air inlet 22 and delivers the pressurised air to an air outlet volute 23 from which it is fed to an internal combustion engine (not shown).

The focus of the present application is the incorporation of a turbine dosing arrangement downstream of the turbine wheel, and specifically the sealing of said dosing arrangement.

Turning to FIG. 2, a perspective view of part of an alternative known turbocharger is provided.

Like that described in connection with FIG. 1, the turbocharger of FIG. 2 comprises a turbine 50 which comprises a turbine housing 52. The turbocharger further comprises a compressor 54 and bearing housing 56 (only part of which are visible in FIG. 2). A primary difference between the known FIG. 1 and FIG. 2 arrangements is that the turbine 50, shown in FIG. 2, incorporates a wastegate 58. In use, the wastegate 58 is actuated so as to divert exhaust gas around a turbine wheel 60 and thereby adjust the mass flow rate of exhaust gas which is expanded across the turbine wheel 60. This, in turn, facilitates the control of the speed (e.g. RPM) of the turbine wheel 60.

When the wastegate 58 is at least partially actuated, so as to open a flow diverting channel, the overall exhaust gas flow is divided into two exhaust streams. A first stream is an exhaust stream which is expanded across the turbine wheel 60. A second stream is that of a bypass flow which has passed through the wastegate 58 (having been diverted around the turbine wheel 60).

FIG. 3 is an end view of part of a turbine assembly 100. The turbine assembly 100 comprises a turbine dosing sealing arrangement according to the disclosure, only part of which is visible in FIG. 3 (and which will be described below).

The turbine assembly 100 comprises a turbine 102 and a diffuser 104. The turbine 102 comprises a turbine housing 106 and a turbine wheel 108. The diffuser 104 comprises an inlet, defining a first cross-sectional area, and a downstream outlet, defining a second cross-sectional area. The FIG. 3 view is taken proximate the outlet. The diffuser 104 is directly supported by, and mounted within, the turbine housing 106.

In use, the turbine wheel 108 rotates, or is rotatable, about a central axis (not shown). The turbine wheel 108 comprises a dosing structure in the form of a dosing cup 110. Such dosing cups are known in the art and will thus not be described in detail in the present application. However, briefly, the dosing cup 110, which rotates with the turbine wheel 108 in use, promotes atomisation of reductant which is expelled by dosing pipe, or conduit, 112. Said atomised reductant is then distributed radially outwardly into an exhaust stream.

The turbine 102 is a wastegated turbine. As such, in use two exhaust flows may flow, or pass, through the turbine assembly 100: a primary, or core, exhaust flow, and a bypass, or secondary, flow. The flows may otherwise be described as streams, e.g. first and second streams. The primary exhaust flow flows through the diffuser 104 (having been expanded across the turbine wheel 108). The bypass flow flows between the diffuser 104 and the turbine housing 106 (having been diverted around the turbine wheel 108, via a wastegate). The bypass flow is a generally annular flow field, a radial extent of which is indicated 121 in FIG. 3. The bypass flow flows between a wall 122 of the diffuser 104 and the turbine housing 106 (specifically a wall 123 defining an outlet portion of the turbine housing 106). The bypass flow can be said to flow through a bypass channel which is a generally annular recess, or cavity, defined between an outer surface 122b of the wall 122 of the diffuser 104 and the wall 123 of the turbine housing 106. The indicator 121, schematically illustrating the radial extent of the annular flow field, is also an indicator of the radial extent of the bypass channel. A number of openings, one of which is labelled 124 in FIG. 3, allow the bypass channel to fluidly communicate with an outlet of the turbine assembly 100. The openings are shaded, relative to the interposing ‘solid’ wall sections, for ease of understanding. The above arrangement is also indicated, in connection with a different embodiment, in FIG. 5 (including bypass channel 409, diffuser 404, turbine housing 406, bypass flow 413a, b, and core flow 417).

Returning to FIG. 3, the dosing pipe, or conduit, 112 is configured to receive, and expel, reductant. For the purposes of this document, reductant may include, for example, diesel exhaust fluid (DEF) such as urea. The reductant may therefore be liquid. The reductant facilitates Selective Catalytic Reduction (SCR) in which harmful NOx emissions are broken down into less reactive compounds. The dosing pipe 112 may be said to inject reductant, in a liquid form, into the exhaust stream downstream of the turbine wheel 108. Put another way, reductant is injected into an exhaust gas flow which has been expanded across the turbine wheel 108. Specifically, the dosing pipe 112 may direct a flow of liquid reductant towards the dosing cup 110 in the turbine wheel 108. In use, when the turbine wheel 108 rotates, the dosing cup 110 promotes atomisation of the liquid reductant, which is then distributed radially outwardly into the exhaust stream. The dosing of reductant downstream of the turbine 108 is advantageous because this is a point in the system upstream of where the SCR catalysts are located.

Whilst it is known to dose reductant into a dosing cup formed in a turbine wheel, or mounted to a turbine wheel, there are a number of issues with existing solutions. For example, in existing solutions a pipe may be inserted through an aperture in the turbine housing and/or diffuser. However, because of the need for the pipe to be generally angled towards the turbine wheel (e.g. L-shaped), the aperture is generally elongate. Issues can be encountered when, in some circumstances, the liquid reductant, or a different form thereof, flows through the aperture, on the outside of the pipe, and contacts the cast metal turbine housing. This is at least because some liquid reductants, such as urea, can form undesirable, and corrosive, by-products. By-products may include, but are not limited to, isocyanic acid, cyanuric acid, ammeline and ammelide. These by-products can be corrosive to metal components (such as turbine housings), and, in particular, cast metal components. The cast metal turbine housings, recited throughout this document, may be cast iron turbine housings.

Although not illustrated in FIG. 3, the dosing pipe 112 receives reductant from an external reductant source, such as a tank or reservoir. The reductant may be pumped from the external source through the dosing pipe 112. Alternatively, the reductant may be fed under gravity, depending upon the orientation of the dosing pipe 112. It will be appreciated that one or more other pipes or hoses, such as a reductant supply line, may interpose the reductant source and the dosing pipe 112.

Whilst the turbine shown in FIG. 3 is a wastegated turbine, it will be appreciated that the dosing pipe 112 and dosing structure 110 may also be present in a non-wastegated turbine (e.g. a fixed geometry turbine). In other words, the dosing pipe 112 and dosing structure 110 may also be present in a turbine where there is no bypass exhaust gas flow. It will be further appreciated that the issues discussed above, such as reductant flowing through the slot, on the outside of the dosing pipe, occur irrespective of whether or not the turbine comprises a wastegate. In other words, it is desirable to overcome the issue of reductant fluid and/or reductant fluid by-product leakage across a range of different varieties of turbine.

FIG. 4 is a cross-section side view of part of a turbine assembly 300 comprising a turbine dosing sealing arrangement 350 in accordance with the disclosure. The turbine dosing sealing arrangement 350, which may be referred to simply as a sealing arrangement, of FIG. 4 is shown in an in-use arrangement, or in an installed configuration, in a wastegated turbine 302.

The turbine 302 comprises a diffuser 304, a turbine housing 306, and a gap or bypass channel 309 defined between a wall 318 (of the diffuser 304) and the turbine housing 306. A bypass flow path is schematically indicated and labelled 303. A core flow path is schematically indicated and labelled 305.

The wall 318 of the diffuser 304 further defines a boss 315. The boss 315 comprises a channel 317 configured to receive a dosing pipe 312 therethrough (only part of the dosing pipe 312 being visible in FIG. 4). The dosing pipe 312 therefore extends through the boss 315, specifically the channel 317 thereof, into an interior 307 of the diffuser 304. Of note, the channel 317, and so boss 315, can be considered to define an aperture, or opening. As described above, the dosing pipe 312 is configured to transport, or transfer, reductant across the turbine housing 306 and/or the diffuser 304 boundary and expel said reductant. The reductant is specifically expelled from the dosing pipe 312 towards a dosing cup, for atomization into, and mixing with, a (core) exhaust gas stream 305 in the diffuser 304.

FIG. 4 illustrates that the channel 317 is larger than an exterior of the dosing pipe 312. Put another way, for a circular channel (or, at a given position along an extent of the boss, aperture) and circular dosing pipe, the internal diameter of the channel (or aperture) is greater than the exterior diameter of the dosing pipe. As mentioned above, this facilitates installation of the dosing pipe 312 by providing a clearance to pass a nonlinear (e.g. curved) portion of the dosing pipe 312 through the channel, or aperture, 317.

However, after reductant has been expelled from the dosing pipe 312, the atomised reductant in the exhaust gas stream, and/or reductant fluid by-products, may condense or form on the dosing pipe 312 and/or on the diffuser 304 itself (specifically on an inner surface 318a of the wall 318). The condensed reductant, and/or reductant fluid by-products, collects, or pools, within the interior 307 of the diffuser 304, at a lowermost point of the diffuser wall 318 (generally under gravity). Said fluid may, were it not for the sealing arrangement 350, then leak through the channel 317 and contact the turbine housing 306. This can lead to undesirable corrosion of the cast iron turbine housing 306. Excess reductant liquid and/or reductant fluid by-product could also drip, or run, down the outer surface of the dosing pipe 312 after engine shutdown. Again, were it not for the sealing arrangement 350, this could result in the fluid contacting the turbine housing 306 and lead to corrosion of the cast iron turbine housing 306. For completeness, conditions such as engine shutdown, and, where the turbine is incorporated in a vehicle, the vehicle travelling either uphill or downhill, are particularly problematic for fluid leaking through the channel 317 (again, if not for the incorporation of the sealing arrangement 350).

The sealing arrangement 350 comprises a sealing member in the form of a plug 354 and a seal 357. The plug 354 comprises a sleeve 353. In FIG. 4, only a portion of the plug 354 of relevance to the present disclosure is shown, and part of the plug 354 is obscured as indicated by the wavy line 311.

The sealing arrangement 350 is provided to advantageously protect the cast iron turbine housing 306 from corrosion caused by reductant liquid and/or reductant fluid by-product. The sealing arrangement 350 also substantially prevents reductant liquid and/or reductant fluid by-product from being able to travel along the gap 309, and contact other components of the turbine 302 (and potentially corroding them).

The sleeve 353 is a generally conical body which is open at a first end 359 (e.g. proximate the diffuser 304), and closed at a second end 361 (e.g. distal the diffuser 304). The dosing pipe 312, in the illustrated embodiment, passes through the inside of the sleeve 353. The first end 359 of the sleeve 353 is proximate the boss 315 when the sealing member is installed. The second end 361 of the sleeve 353 is distal the boss 315 when installed. The first end 359 of the sleeve 353 engages the boss 315 indirectly, via the seal 357 (as will be described below). The sleeve 353 is manufactured from stainless steel, and is therefore resistant to corrosion from, for example, reductant liquid and/or reductant fluid by-products.

The seal 357 is provided between the first end 359 of the sleeve 353 and the boss 315 of the diffuser 304. The seal 357 is an inert seal, for example a graphite seal. The seal 357 is inert such that it is resistant to corrosion from reductant liquid and/or reductant fluid by-product. The seal 357 is also inert to the relatively high temperatures to which it is exposed (which may be in excess of 1,000° C.). The seal 357 is also a compliant seal in that it can elastically deform, or be compressed. The seal 357 may otherwise be described as a resiliently biased seal. In use, the seal 357 is sandwiched, or disposed, between the sleeve 353 and the boss 315. The seal 357 is a generally annular gasket. The seal 358 is seated in a corresponding seal recess provided at the first end 359 of the sleeve 353. To facilitate installation of the sealing arrangement 350, the seal 357 may be affixed to the sleeve 353 such that the sealing member be installed as a unitary component. Where the seal 357 and the boss 315 contact one another, or engage, an interface is defined. In the illustrated embodiment the interface is a generally annular surface. The dosing pipe 312 extends past, or across, the interface. The interface defines a point past which fluid is substantially prevented from passing (save for fluid passing along, or through, the dosing pipe 312). The interface can therefore be said to define an outer end of a sealing ‘zone’.

In the embodiment shown in FIG. 4, the seal 357 and sleeve 353 are provided, or extend, around an outer surface 319 of the boss 315. However, in other arrangements the seal 357 and the sleeve 353 may be disposed within the channel 317 of the boss 315. Put another way, the interface may be defined, at least in part, by an inner surface 321 of the boss 315 (e.g. such that the sealing member is at least partly disposed within the channel 317).

The plug 354 defines a cavity 360. The cavity 360 is for the collection of fluid (and specifically for the collection of any leakage fluid). The cavity 360 may therefore be referred to as a fluid cavity. The dosing pipe 312 extends though the cavity 360. The dosing pipe 312 further extends through the boss 315 via the channel 317. Reductant fluid and/or reductant fluid by-product which undesirably leaks through the channel 317 is collected in the cavity 360. Because the cavity 360 is defined by components manufactured from stainless steel, or any other corrosion-resistant material, the ‘leaked’ fluid can be stored in the cavity 360 to reduce the risk of it contacting, and corroding, the cast metal turbine housing 306.

It will be appreciated that reductant fluid may remain in the cavity 360 after engine shutdown. When the engine restarts, the high temperature exhaust gases, which travel through the diffuser 304 and the bypass channel 309, will cause the sleeve 353 to increase in temperature and hence burn off any remaining fluid in the cavity 360. Such evaporation of collected fluid, from the cavity 360, reduces the risk of the cavity from overfilling.

The sleeve 353 may form a press fit, or interference fit, with the turbine housing 306. That is to say, the sleeve 353 may be pressed onto the turbine housing 306. The sleeve extends from the diffuser 304 through, and past, the turbine housing 306 so to ensure that liquid in the cavity 360 does not contact the turbine housing 306. The second end 361 of the sleeve 353 seals the cavity 360.

For completeness, the turbine housing 306 also defines a boss 313. The boss 313, in turn, defines a channel 323. The dosing pipe 312 extends through the channel 323, and through boss 313. The sleeve 353 extends through an entirety of the channel 323. The cap 355 is located outside of the channel 323, and so boss 313, in the illustrated arrangement. It will be appreciated that the channel 323, and channel 317, may otherwise be described as recesses. It will also be appreciated that the channel 323 may be said to define an aperture at any point along an extent of the boss 313.

The sealing arrangement 350 as shown in FIG. 4 also provides an improved method of assembling a turbine assembly 300 (incorporating the sealing arrangement 350). First, the diffuser 304 may be press fitted, and/or staked, into position with, and relative to, the turbine housing 306. The seal 357 is then placed, or seated, onto the first end 359 of the sleeve 353 (although, in other embodiments, the seal 357 may be placed, or seated, onto the outer surface 319 of the boss 315). The sleeve 353 is then urged into place through the channel 323 of the turbine housing 306 and over the boss 315. The seal 357 is then provided in engagement with, and compressed by, the sleeve 353 and the boss 315 (defining the interface). The seal 357 is therefore retained by the sleeve 353. The sleeve 353 may also be retained by an interference fit with the boss 315, or alternatively by a fastener or other retaining means. The seal 357 may be described as being urged towards the wall 318 of the diffuser 304. The dosing pipe 312 is then inserted through the channel 323 defined by the turbine housing 306, and the channel 317 defined by the diffuser 304, through the sleeve 353. The dosing pipe 312 is then manoeuvred such that an end of the dosing pipe, which is disposed in the diffuser 304, is directed towards the turbine wheel (not visible in FIG. 4). The channel 323 is thus closed, or sealed. The dosing pipe 312 is retained by the sleeve 353 or some other retention means. The dosing pipe 312 is thus disposed within (e.g. extending through) the sleeve 353. The sleeve 353 may be secured using a press fit, fastener or other attachment means. The sleeve 353 may be said to be urged against, or towards, the boss 315. The cavity 360 of the sleeve 353, in which the dosing pipe 312 is disposed, reduces the risk of damage to the dosing pipe 312 during assembly because no significant insertion forces need to be applied to the dosing pipe 312. To further secure the sleeve 353 to the boss 313, the sleeve 353 may be staked to the turbine housing 306 (specifically the boss 313 thereof). The dosing pipe 312 is, at some point during the assembly process, connected to a reductant supply. This may be the final step (i.e. after all other components have been secured in position). In an alternative method, the dosing pipe 312 may be inserted through the channel 317 from an interior of the diffuser 304. That is to say, rather than the dosing pipe 312 being inserted in a radially inwardly direction, relative to the axis of rotation of the turbine wheel, the dosing pipe 312 may be inserted in a radially outwardly direction. In order for the dosing pipe 312 to be insertable in this way, the dosing pipe 312 may be nonlinear (e.g. arcuate).

In some embodiments the diffuser 304 may be integral with the turbine housing 306. As such, the associated steps of inserting the diffuser 304 into the turbine housing 306 may be omitted from the above described method in said embodiments.

The sealing arrangement 350 comprises the sealing member, in the form of the plug 354 and the seal 357, and the dosing pipe 312. The sealing member (specifically the seal 357) engages the diffuser 304, specifically boss 315 thereof, to define an interface therebetween. The interface takes the form of a generally annular boundary, or contact face, which extends around the outer surface 319 of the boss 315. The dosing pipe 312 projects from the sealing member, specifically the cap 363 thereof. The dosing pipe 312 defines at least part of a reductant fluid pathway across the interface. Put another way, the dosing pipe 312 extends through a centre of the annular interface. The sealing arrangement thus advantageously reduces, or prevents, fluid leakage across the interface, whilst permitting the flow of reductant, via the dosing pipe 312, thereacross. In the FIG. 4 arrangement, a further interface is defined between an exterior of the sleeve 353 and an interior of the boss 313 of the turbine housing 306. That is to say, another sealing boundary is defined, reducing or preventing fluid leakage thereacross, whilst reductant fluid can still cross the sealing boundary through the dosing pipe 312.

Turning to FIG. 5, a cross-section side view of part of a turbine assembly 400, comprising a turbine dosing sealing arrangement 450 according to another embodiment of the disclosure, is illustrated. The FIG. 5 arrangement shares some features in common with the embodiment described in connection with FIG. 3.

Returning to FIG. 5, the turbine assembly 400 comprises a turbine 402 (partly visible in FIG. 5) and a diffuser 404. The turbine 402 comprises a turbine housing 406 and a turbine wheel 408 (both of which are only partly visible in FIG. 5). The turbine wheel 408 comprises a dosing cup 410, and rotates about a central axis 407.

A gap, or bypass channel, 409 is defined between the diffuser 404 and the turbine housing 406. Specifically, the bypass channel 409 may be said to be defined between a wall 418, forming part of the diffuser 404, and an outlet portion 403 of the turbine housing 406. Secondary, or bypass, exhaust gases 413a, b flow through the bypass channel 409. A primary, or core, exhaust gas flow 417 passes through an interior of the diffuser 404. As described in connection with FIGS. 2 and 3, the secondary, or bypass, exhaust gases 413a, 413b are those which are diverted around the turbine wheel 408, by a wastegate. The primary, or core, exhaust gas flow is the exhaust gas flow which is expanded across the turbine wheel 408 (and which drives rotation of the compressor wheel [not shown in FIG. 5]).

In FIG. 5, the sealing arrangement 450 comprises a sealing member, in the form of a plug 430, and a dosing pipe 412. The dosing pipe 412 extends towards the dosing cup 410, and is received within the dosing cup 410. In the FIG. 5 embodiment, the plug 430 and dosing pipe 412 are installed simultaneously. The combination of the plug 430 and dosing pipe 412 may be attached to one another, as a sub-assembly, before the ‘single’ combined sub-assembly is then installed in the turbine assembly 400. Said attachment may be by brazing, welding, or some other attachment process which is suitable for the high temperatures which the surrounding exhaust gases reach in operation.

The plug 430 sealingly engages the dosing pipe 412, thereby reducing, or preventing, reductant fluid and/or reductant fluid by-product, that may be present on an outer surface of the dosing pipe 412, from penetrating the plug 430 (e.g. passing between the plug 430 and the dosing pipe 412).

During installation, the dosing pipe 412 is inserted through channels 419, 421 in both the turbine housing 406 and the diffuser 404. The channel 421, defined in the diffuser 404, is specifically provided through a boss 415 defined in the wall 418. The channel 412 may be said to define an aperture along an extent of the boss 415. Similarly, the channel 419, in the turbine housing 406, may be said to define an aperture along an extent of the channel 419. The channel 419 of the turbine housing 406 may be described as being provided through a boss 429 defined in the turbine housing 406. Preferably the dosing pipe 412 and the plug 430 are installed simultaneously as a ‘sub-assembly’.

The dosing pipe 412 comprises a bend, or change in direction. The dosing pipe 412 may therefore be considered to be L-shaped, or non-linear. Such geometry facilitates the direction of reductant fluid from the pipe towards the dosing cup 410. As described in connection with previous embodiments, the aperture 412 of the diffuser wall 418 is sufficiently large to accommodate the bend in the dosing pipe 412 during insertion of the dosing pipe 412 through the aperture 421. The aperture 421 may therefore be an elongate aperture. As described in connection with earlier embodiments, the clearance, which exists to facilitate the insertion of the nonlinear dosing pipe 412 through the aperture 421, can also be a leakage pathway. Said leakage pathway could facilitate corrosion of the cast metal turbine housing, were it not for the incorporation of a sealing arrangement 450 as per the disclosure.

The sealing arrangement 450 is provided to reduce the risk of corrosive liquids, such as corrosive by-products resulting from reductant fluid, from contacting, and corroding, the cast iron turbine housing 406. This is achieved whilst still providing a fluid pathway, via the dosing pipe 412, by which reductant fluid can be dosed, or injected, into an exhaust gas stream downstream of the turbine wheel 408.

As mentioned above, the sealing arrangement 450 comprises the plug 430 and the dosing pipe 412. The plug 430 is a generally solid body, save for a bore 423. The plug 430 comprises outer ends 425, 427, which may be described as first and second ends respectively. The outer end 425 opposes the outer end 427 in the illustrated embodiment. The bore 423 extends between the outer ends 425, 427 of the plug 430, defining a generally cylindrical recess through the plug 430. The bore 423 may be described as a central bore.

The dosing pipe 412 may be described as a conduit. The dosing pipe 412 extends through the bore 423. In the FIG. 5 embodiment the dosing pipe 412 extends through the entirety of the bore 423. That is to say, the dosing pipe 412 projects from both outer ends 425, 427 of the plug 430. In other embodiments (not shown) the dosing pipe 412 may only extend through a portion of the bore 423 of the plug 430, or may not extend through the bore 432 whatsoever (e.g. it may simply be in fluid communication with the bore 432). In other embodiments, the dosing pipe 412 may be integrally formed with the plug 430. Such embodiments may be manufactured by, for example, additive manufacture.

An inert seal, in the form of a graphite seal 435, also forms part of the sealing arrangement 450. The graphite seal 435 may be referred to as a first seal. The graphite seal 435 is provided proximate the first end of the plug 430. The graphite seal 435 is an O-ring in the illustrated embodiment, but it will be appreciated that other seal varieties, and geometries, may otherwise be incorporated. The graphite seal 435 is disposed between the plug 430 and the channel 421 (specifically an inner surface of the boss 415 which defines the channel 421) of the diffuser 404. As such, the graphite seal 435 provides a seal between the plug 430 and the channel 421 of the diffuser 404. The graphite seal 435 therefore defines the interface between the sealing member (e.g. the plug 430 and the graphite seal 435) and the diffuser 404. The graphite seal 435 is both resistant to corrosion, and suitable for use in high temperature environments (such as those experienced in the turbine assembly 400). The graphite seal 435 is therefore resistant to corrosion by reductant fluid and/or reductant fluid by-product, reducing the risk of said fluids from contacting, and corroding, the turbine housing 406. The graphite seal 435 may be a compliant seal which is compressed between the plug 430 and the diffuser 404. The graphite seal 435 may be seated in a corresponding recess in the plug 430.

A second seal 437 is provided proximate the second end 427 of the plug 430. The second seal 437 is disposed between the plug 430 and the turbine housing 404. The sealing arrangement 450 further comprises a second seal 437. The second seal 437 is a C-seal (e.g. having a cross-section in the shape of a ‘C’), but it may be any other suitable seal, such as an O-ring seal. The second seal 437 is provided to reduce, or prevent, gas leakage, in particular bypass exhaust gas 413a, b from leaking out of the bypass channel 409 via the channel defined through the boss 429. Because the bypass exhaust gas 413a, b in the bypass channel 409 does not have reductant fluid atomised into it, the second seal 437 may not need to be as corrosion-resistant at the graphite seal 435. The second seal 437 may therefore not be formed from graphite. However, it will be appreciated that the second seal 437 should still be able to withstand high temperatures, e.g. in excess of 1000° Celsius, without failing.

The plug 430 further comprises a flanged portion 439. The flanged portion 439 is disposed at the second end 427 of the plug 430. The flanged portion 439 is configured to be flush against a proximate outer surface of the turbine housing 406, specifically an outer surface of the boss 429 thereof. The flanged portion 439 is configured to engage the turbine housing 406, specifically the boss 429 thereof. The flanged portion 439, and so sealing arrangement 450 more generally, is secured in position by a plurality of fasteners 441, 443 (only two of which are visible in FIG. 5).

The flanged portion 439 serves a number of purposes. A first functionality is that the flanged portion 439 facilitates the plug 430 being secured in its in use configuration. Put another way, the flanged portion 439 can be used, in combination with fasteners 441, 443, to secure the plug 430 in an installed position (like that shown in FIG. 5). The turbine assembly 400, when in use, is subject to various vibrations. Securing the flange portion 439 to the turbine housing 406 reduces the risk of the plug 430 from being dislodged, which could otherwise lead to the graphite seal 435 not forming a secure seal, and corrosive fluid leaking from the diffuser 404 through to the turbine housing 406. The flanged portion 439 also provides an additional barrier to prevent exhaust gas leakage, in the event that exhaust gas leaks through the second seal 437. The flanged portion 439 therefore reduces the risk of exhaust gases leaking out of the turbine housing 406. The flanged portion 439 also provides a robust, and sizeable, surface to aid the installation of the sealing arrangement 450. For example, a compressive force could be safely applied to the flange portion 439, without risking damage to the more fragile features of the sealing arrangement 450.

The flanged portion 439 may be secured to the turbine housing 406 by one or more fasteners. The fasteners may include screws, bolts, rivets, welded sections or any other suitable fastening or securing means. Preferably, the fastener is a removable, or replaceable, fastener, such that the sealing arrangement 450 can be replaceably removed from the turbine assembly 400. This is particularly useful when testing the components of the turbine assembly 400, or replacing individual parts. The fasteners 441, 443 shown in FIG. 5 are bolts. The bolts secure the flanged portion 439 against the turbine housing 406. The fasteners thus retain the plug 430, and pipe 412, in their desired position. The seals 437 reduce the risk of fluid leakage past, or across, the flanged portion 439.

An outer profile of the plug 430 defines a plurality of steps. Each step comprises a first and second portion that are generally orthogonal to one another. The steps of the plug 430 may engage with complementary steps of the turbine housing 406 and/or the diffuser 404 (and specifically interiors of bosses 429, 415 thereof). The complementary steps help to further mitigate against exhaust gas leakage from the diffuser 404 or the bypass channel 409. The plug 430 may be described as having a stepped geometry. The flanged portion 439 may define a widest step, with subsequent steps being smaller than the flanged portion 439. The steps may define a generally tapering outer profile of the plug 430 (e.g. an outer diameter of the plug 430 may gradually reduce moving from the second end 427 towards the first end 425).

The plug 430 may comprise one or more location features (not shown in FIG. 5). Said location features may take the form of recesses and/or protrusions defined by an outer surface, or profile, of the plug 430. The turbine housing 406 and/or the diffuser 404 may also comprise one or more complementary, or cooperative, location features (again, not shown in FIG. 5). Said complementary, or cooperative, location features may take the form of protrusions and/or recesses (not shown). Such location features facilitate the correct orientation of the sealing arrangement 450 relative to the turbine housing 406 and/or diffuser 404, during installation and in situ.

The sealing arrangement 450 comprises the sealing member, in the form of the plug 430 and the seals 435, 437, and the dosing pipe 312. The sealing member (specifically the seal 435) engages the diffuser 404, specifically boss 415 thereof, to define an interface therebetween. The interface takes the form of a generally annular boundary, or contact face, which extends around an inner surface of the boss 415. The dosing pipe 412 projects from the sealing member. The dosing pipe 412 defines at least part of a reductant fluid pathway across the interface. Put another way, the dosing pipe 412 extends through a centre of the annular interface. The sealing arrangement 450 thus advantageously reduces, or prevents, fluid leakage across the interface, whilst permitting the flow of reductant, via the dosing pipe 412, thereacross. In the FIG. 5 arrangement, a further interface is defined between the plug 430 and an interior, or inner surface, of the boss 415 of the turbine housing 406. That is to say, another sealing boundary is defined, reducing or preventing fluid leakage thereacross, whilst reductant fluid can still cross the sealing boundary through the dosing pipe 412.

FIG. 6a is a cross-section side view of a turbine assembly 500 comprising a turbine dosing sealing arrangement 550 according to another embodiment of the disclosure. FIG. 6b is an enlarged cross-section view of the turbine dosing sealing arrangement 550 according to FIG. 6a.

The turbine assembly 500 comprises a turbine 502 and a diffuser 504. The turbine 502 comprises a turbine housing 506 and a turbine wheel 508. The turbine wheel 508 comprises a dosing cup 510. The turbine wheel 508 rotates about a central axis 505.

The turbine assembly 500 shown in FIG. 6a differs from the embodiments illustrated in FIGS. 3 to 5 for at least the reason that there is no gap, or bypass channel, between the turbine housing 506 and the diffuser 504. Indeed, unlike the previous embodiments, the diffuser 504 is not received ‘within’ the turbine housing 506. Instead, the turbine housing 506 engages the diffuser 504 in a substantially axial manner (e.g. the turbine housing 506 and diffuser 504 are in engagement in an end-to-end manner only). As such, the turbine assembly 500 of FIG. 6a is a not a wastegated turbine, and is instead a fixed geometry turbine. Nevertheless, the skilled person would recognize how the sealing arrangement 550, discussed below, could alternatively be applied to a wastegated turbine (for example).

The diffuser 504 is secured to the turbine housing 506 via a band clamp 507, such as a marman clamp, which extends around the central axis 505. Specifically, the band clamp 507 draws respective flanges 509, 511 of the turbine housing 506 and diffuser 504 into engagement with one another.

Like the previous embodiments, the sealing arrangement 550 comprises a dosing pipe 512 and a sealing member. Similarly, the diffuser 504 comprises a wall 503, in which a boss 515 is provided. The boss 515 defines a channel 517, which can be considered to define an aperture. During installation, the dosing pipe 512 is inserted through the channel 517 such that it projects into an interior of the diffuser 504 (e.g. past the wall 503). The dosing pipe 512 is angled towards the turbine wheel 508, and received by the dosing cup 510. The channel 517 is therefore sufficiently large that the nonlinear dosing pipe 512 can be received therethrough. The clearance which exists around the outside of the dosing pipe 512, between the exterior and the aperture provided in the wall 503, could provide a leakage path, across the wall 503, were it not for the incorporation of the sealing arrangement 550. Said leakage path could otherwise lead to the undesirable corrosion of surrounding components. The components which make up the sealing arrangement 550 will be described in more detail below, in connection with FIG. 6b.

FIG. 6b is an enlarged cross-section side view of the sealing arrangement 550 of FIG. 6a.

The sealing arrangement 550 comprises the sealing member in the form of a plug 530 and a compression fitting member 531. The plug 530 engages the diffuser 504, specifically the channel 517 of the boss 515 thereof, at an interface. Said engagement greatly reduces, or prevents, the leakage of fluid past the interface. Specifically, the plug 530 is disposed in a narrower portion 517a of the channel 517. The dosing pipe 512 extends through the plug 530 and, in the illustrated embodiment, does not extend into the compression fitting member 531. The dosing pipe 512 is integral with the plug 530.

The compression fitting member 531 is partly disposed in a wider portion 517b of the channel 517. The compression fitting member 531 defines a bore 570, which may be referred to as a central channel. The compression fitting member 531 allows a second conduit 514, which may be a flexible hose, such as rubber pipe or tube, to be provided in fluid communication with the dosing pipe 512, without fluid leaking from the connection point. The connection point being the point between the plug 530 and the compression fitting member 531. It is advantageous for the dosing pipe 512 to be able to be securely joined to a more flexible conduit because the source, or reservoir, of reductant fluid may not be provided in close proximity to the dosing pipe 512. The flexible hose may be around 6 mm in diameter.

Between the plug 530 and the compression fitting member 531, a washer 561, in particular a conical spring or Bellville washer, is provided. The washer 561 has a frustoconcial shape. The washer 561 transmits a force, exerted by the compression fitting member 531, onto the plug 530. Said force improves the seal achieved by the plug 530. The washer 561 may be exchanged for a stack of washers in other embodiments. When the force required to be transmitted onto the plug is comparatively larger, a stack of washers is preferable. This is at least because a stack or a plurality of washers 561 allows a greater force to be transmitted onto the plug 530.

The force exerted by the compression fitting member 531 on the plug 530, via the washer 561, is adjustable by rotating the compression fitting member 531. Put another way, by varying the extent to which the compression fitting member 531 threadably engages the boss 515, the extent to which the plug 530 is urged by the compression fitting member 531 can be varied.

Like that described in connection with the previous embodiment, the plug 530 and/or compression fitting member 531 may comprise one or more location features, in the form of recesses or protrusions. The diffuser 504, specifically the boss 515 thereof, may similar comprise one or more corresponding location features, which may be in the form of protrusions or recesses. Cooperation between the location features facilitate the alignment and/or positioning of the sealing arrangement 550 relative to the diffuser 504.

The dosing pipe 512 may extend through the entire length of the central channel 570, or it may extend through only a portion of the central channel 570.

The sealing arrangement 550 comprises the sealing member, in the form of the plug 530 and the compression fitting member 531, and the dosing pipe 512. The sealing member (specifically the seal plug 530) engages the diffuser 504, specifically boss 515 thereof, to define an interface therebetween. The interface takes the form of a generally annular boundary, or contact face, which extends around an inner surface of the boss 415. The dosing pipe 512 projects from the sealing member. The dosing pipe 512 defines at least part of a reductant fluid pathway across the interface. Put another way, the dosing pipe 512 extends through a centre of the annular interface. The sealing arrangement 550 thus advantageously reduces, or prevents, fluid leakage across the interface, whilst permitting the flow of reductant, via the dosing pipe 512, thereacross. In the FIGS. 6a and 6b arrangement, a further interface is defined between the compression fitting member 531 and the boss 515 of the turbine housing 506.

FIG. 7 is a cross-section side view of part of a turbine assembly 600 comprising a turbine dosing sealing arrangement 650 according to another embodiment of the disclosure, and a turbine housing element, in the form of a diffuser 604, according to another embodiment of the disclosure. The sealing arrangement 650 is shown in its in use, or installed, configuration in the turbine assembly 600. A central axis 601, about which the diffuser 604 and a turbine housing 606 extend around, is also schematically indicated.

The turbine assembly 600 comprises the diffuser 604, defined by a diffuser wall 618, and the turbine housing 606. A gap, or bypass passage, 609 is defined between the diffuser wall 618 and the turbine housing 606. Said gap provides a flowpath for bypass exhaust gases in a wastegated turbine, like that described in connection with FIGS. 3 to 6. The diffuser wall 618 extends between an inlet 617 and an axially offset outlet 613 (e.g. offset along the central axis 601). The diffuser wall 618 defines an inner surface 618a (e.g. proximate the central axis 601) and an outer surface 618b (e.g. distal the central axis 601).

The diffuser wall 618 defines a diffuser bore, or interior, 603 through which exhaust gas that has been expanded across a turbine wheel (not shown) passes. For the purposes of FIG. 7, the bore 603 of the diffuser 604 is bound by a surface of the diffuser wall 618 which is proximate the central axis 601.

A dosing pipe 619 is integrally formed with the diffuser wall 618 (specifically the inner surface 618a thereof). The dosing pipe 619 and diffuser wall 618 form a single, monolithic component. The dosing pipe 619 extends into the diffuser bore 603. The dosing pipe 619 is directed towards the turbine wheel in use. The dosing pipe 619 is, as per the previous embodiments, configured to receive and expel reductant fluid towards the turbine wheel.

The dosing pipe 619 comprises a bend, or change in direction, to enable the reductant fluid that is expelled from the dosing pipe 619 to be directed towards the turbine wheel. The dosing pipe may therefore be described as nonlinear.

Advantageously, integrally forming the dosing pipe 619 with the diffuser wall 618 removes a leakage path between an exterior of the dosing pipe 619 and the diffuser wall 618. In other words, there is no gap around the dosing pipe 619 through which fluid can leak towards the turbine housing 606. Advantageously, the risk of the turbine housing 606 corroding is reduced as a result.

The diffuser wall 618 may further define a boss 630. The boss 630 is configured to engage a feeder conduit 620 (which may, itself, be referred to as a dosing pipe or conduit). The boss 630 comprises a channel 605 in fluid communication with the dosing pipe 619. The channel 605, or the boss 630 more generally, comprises an attachment portion in the form of a screw thread 607. A first end 621 of the feeder conduit 620, proximate the boss 630 in use, comprises a corresponding attachment portion in the form of a screw thread 611. The feeder conduit 620 can therefore threadably engage the boss 630. Said threaded engagement places the feeder conduit 620, and dosing pipe 619, in sealed fluid communication with one another.

In FIG. 7, the feeder conduit 620 engages an internal surface of the boss 630.

Alternatively, the feeder conduit 620 may surround the boss 630, such that the feeder conduit 620 engages an exterior surface of the boss 630.

The threaded connection between the feeder conduit 620 and the boss 630 reduces the risk of any reductant fluid and/or reductant fluid by-product leaking through the boss 630 and contacting the turbine housing 606. Said threaded connection thereby reduces the risk of the turbine housing 606 corroding.

During maintenance, repair or testing of the turbine 600 assembly, the feeder conduit 620 can readily be unscrewed from the boss 630, and can either be replaced by a new conduit or subsequently re-attached.

Further, the feeder conduit 620 extends through the turbine housing 606. Specifically, the feeder conduit 620 extends through a channel 653 defined in a wall of the turbine housing 606. A sealing member, in the form of a compression fitting member 657, is provided to seal the channel 653 through which the conduit 620 extends. The compression fitting member 657 thus prevents exhaust gas leakage from the bypass passage 609.

The compression fitting member 657 may comprise two portions: a mounting member 656 and a sealing element 659.

The mounting member 656 is secured to the turbine housing 606. In the illustrated embodiment the mounting member 656 is secured to the turbine housing 606 using fasteners 670, 671. The fasteners 670, 671 may include, for example, screws, bolts and rivets. The mounting member 656 may alternatively be secured to the turbine housing 606 by welding or any other suitable securing means. Preferably the mounting member 656 is detachably secured to the turbine housing 606 such it can easily be removed and/or replaced without damaging the turbine housing 606. The mounting member engages the turbine housing 606 to define an interface therebetween. The interface is of the form of an annular ‘contact’ face between the mounting member 656 and the turbine housing 606.

The sealing element 659 is provided to mitigate against exhaust gas leaking from the bypass channel 609. The sealing element 659, in FIG. 7, is a compression nut, but other sealing members may otherwise be used.

Disposed around the feeder conduit 620 is an olive 661. The olive 661 is a deformable, generally annular, body of material. The olive 661 is made from copper. The mounting member 656 is partly disposed around the olive 661 and has a tapered surface. The sealing element 659 which is partly disposed around the olive 661 also has a tapered surface. As the sealing element 659 is tightened, the olive 661 is compressed. Compression of the olive 661 causes a mechanical seal to be formed effectively between the olive 661 and the turbine housing 606. The mechanical seal mitigates against exhaust gas leaking from the bypass channel 609.

A flexible tube or hose 690 (partly shown in FIG. 7), such as a rubber tube, is shown connected to, and in fluid communication with, the feeder conduit 620. Specifically, a mounting flange 692 of the flexible tube 690 is shown in engagement with a flange 673 of the feeder conduit 620. The flanges 692, 673 may be secured together using a band clamp or other retaining means. Said flexible tube 690 may be configured to transport reductant fluid from a source, or reservoir, to the feeder conduit 620 (and so dosing pipe 619).

Throughout this document, the terms dosing pipe and conduit may be used interchangeably. Turbine housing element may refer to a turbine housing, a diffuser, or an adapter element. Turbine dosing sealing arrangement may otherwise be referred to as a sealing arrangement for brevity.

One of more of the turbine dosing sealing arrangements described above may be manufactured as a single, integrally formed component. That is to say, the dosing pipe may be integrally formed with the sealing member. Alternatively, the dosing pipe may be a separate component to that of the sealing member. Where integrally formed with one another, the turbine dosing sealing arrangement may be cast, such as investment cast, or may be manufactured by an additive manufacture method.

A common example of additive manufacturing is 3D printing; however, other methods of additive manufacturing are available. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a three-dimensional component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using prior manufacturing methods.

Additive manufacturing methods described herein enable manufacture to any suitable size and shape with various features which may not have been possible using prior manufacturing methods. Additive manufacturing can create complex geometries without the use of any sort of tools, molds or fixtures, and with little or no waste material. Instead of machining components from solid billets of plastic or metal, much of which is cut away and discarded, the only material used in additive manufacturing is what is required to shape the part.

Additive manufacturing methods described herein enable manufacture to any suitable size and shape with various features which may not have been possible using prior manufacturing methods. Additive manufacturing can create complex geometries without the use of any sort of tools, molds or fixtures, and with little or no waste material. Instead of machining components from solid billets of plastic or metal, much of which is cut away and discarded, the only material used in additive manufacturing is what is required to shape the part.

The additive manufacturing processes described herein may be used for forming components using any suitable material. For example, the material may be metal or any other suitable material that may be in solid, liquid, powder, sheet material, wire, or any other suitable form or combinations thereof. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, iron, iron alloys, stainless steel, and nickel or cobalt based superalloys (e.g., those available under the name Inconel® available from Special Metals Corporation). These materials are examples of materials suitable for use in additive manufacturing processes which may be suitable for the fabrication of examples described herein.

As noted above, the additive manufacturing process disclosed herein allows a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on three-dimensional (3D) information, for example a three-dimensional computer model (or design file), of the component.

Accordingly, examples described herein not only include products or components as described herein, but also methods of manufacturing such products or components via additive manufacturing and computer software, firmware or hardware for controlling the manufacture of such products via additive manufacturing.

The structure of one or more parts of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any three-dimensional object to be fabricated on any additive manufacturing printer.

Further examples of design file formats include AutoCAD (.dwg) files, Blender (.blend) files, Parasolid (.x_t) files, 3D Manufacturing Format (0.3mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product.

Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known computer aided design (CAD) software systems such as AutoCAD®, TurboCAD®, DesignCAD 3D Max, etc. Alternatively, a model or prototype of the component may be scanned to determine the three-dimensional information of the component.

Accordingly, by controlling an additive manufacturing apparatus according to the computer executable instructions, the additive manufacturing apparatus can be instructed to print out one or more parts of the product. These can be printed either in assembled or unassembled form. For instance, different sections of the product may be printed separately (as a kit of unassembled parts) and then subsequently assembled. Alternatively, the different parts may be printed in assembled form.

In light of the above, embodiments include methods of manufacture via additive manufacturing. This includes the steps of obtaining a design file representing the product and instructing an additive manufacturing apparatus to manufacture the product in assembled or unassembled form according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing device. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing device.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

The described and illustrated embodiments are to be considered as illustrative and not restrictive in character, it being understood that only preferred embodiments have been shown and described and that all changes and modifications that come within the scope of the disclosures as defined in the claims are desired to be protected. In relation to the claims, it is intended that when words such as “a,” “an,” “at least one,” or “at least one portion” are used to preface a feature there is no intention to limit the claim to only one such feature unless specifically stated to the contrary in the claim. When the language “at least a portion” and/or “a portion” is used the item can include a portion and/or the entire item unless specifically stated to the contrary.

Optional and/or preferred features as set out herein may be used either individually or in combination with each other where appropriate and particularly in the combinations as set out in the accompanying claims. The optional and/or preferred features for each aspect of the disclosure set out herein are also applicable to any other aspects of the disclosure, where appropriate.

1. A turbine dosing sealing arrangement comprising:
a sealing member configured to engage a turbine housing element at an interface; and
a conduit which projects from the sealing member, the conduit defining at least part of a reductant fluid pathway across the interface.

2. The turbine dosing sealing arrangement according to claim 1, wherein the sealing member comprises a plug, and wherein the conduit extends from the plug.

3. The turbine dosing sealing arrangement according to claim 2, wherein the plug comprises a cavity for the collection of fluid.

4. The turbine dosing sealing arrangement according to claim 2, wherein the plug comprises a sleeve.

5. The turbine dosing sealing arrangement according to claim 4, wherein the conduit extends through the sleeve.

6. The turbine dosing sealing arrangement according to claim 1, wherein the sealing member comprises an inert seal.

7. (canceled)

8. The turbine dosing sealing arrangement according to claim 6, wherein the inert seal is a first seal, the sealing member further comprises a second seal; and
wherein the first and second seals are spaced apart.

9. The turbine dosing sealing arrangement according to claim 1, wherein the sealing member comprises a compression fitting member.

10. The turbine dosing sealing arrangement according to claim 9, wherein the compression fitting member defines a bore.

11. (canceled)

12. (canceled)

13. The turbine dosing assembly for a turbine, the turbine dosing assembly comprising:
a turbine housing element; and
the turbine dosing sealing arrangement according claim 1.

14. The turbine dosing assembly according to claim 13, wherein the turbine housing element comprises a boss; and wherein the interface is defined at least partly by the boss.

15. The turbine dosing assembly according to claim 14, wherein the sealing member engages the boss.

16. The turbine dosing assembly according to claim 14, wherein the sealing member comprises a plug, and wherein the conduit extends from the plug, and wherein a portion of the plug is received within the boss.

17. The turbine dosing assembly according to claim 13, wherein the sealing member comprises a plug, and wherein the conduit extends from the plug, and wherein:
the turbine housing element is a first turbine housing element; and
wherein a portion of the plug engages a second turbine housing element.

18. The turbine dosing assembly according to claim 16 wherein the sealing member comprises an inert seal, and wherein the inert seal is disposed between the boss and the plug.

19. The turbine assembly comprising:
a turbine wheel; and
the turbine dosing assembly according to claim 13.

20. The turbocharger comprising:
a compressor;
a bearing housing; and
the turbine assembly according to claim 19;
wherein the turbine and compressor are in power communication.

21. (canceled)

22. The computer program comprising computer executable instructions that, when executed by a processor, cause the processor to control an additive manufacturing apparatus to manufacture a turbine dosing sealing arrangement, optionally according to claim 1.

23. The method of installing a turbine dosing sealing arrangement according to claim 1, the method comprising:
urging the sealing member into engagement with the turbine housing element.

24. The method of manufacturing a turbine dosing sealing arrangement, via additive manufacturing, the method comprising:
obtaining an electronic file representing a geometry of the turbine dosing sealing arrangement or the turbine housing element; and
controlling an additive manufacturing apparatus to manufacture, over one or more additive manufacturing steps, the turbine dosing sealing arrangement, according to the geometry specified in the electronic file;
optionally wherein the turbine dosing sealing arrangement is according to claim 1.
